(19) United States
(12) Patent Application Publication
(10) Pub. No.: US 2012/0082253 A1
(43) Pub. Date: Apr. 5, 2012

(54) Pilot Structure for Coherent Modulation

(75) Inventors: Badri Varadarajan, Mountain View, CA (US); Anand Dabak, Plano, TX (US); Il Han Kim, Dallas, TX (US); Akula Aneesh Reddy, Austin, TX (US)

(73) Assignee: TEXAS INSTRUMENTS INCORPORATED, Dallas, TX (US)

(21) Appl. No.: 13/175,045

(22) Filed: Jul. 1, 2011

Related U.S. Application Data
(60) Provisional application No. 61/363,335, filed on Jul. 12, 2010.
(60) Provisional application No. 61/380,917, filed on Sep. 8, 2010.
(60) Provisional application No. 61/391,359, filed on Oct. 8, 2010.

(51) Int. Cl. H04B 15/00; H04L 27/06; H04L 27/28

(52) U.S. Cl. 375/260; 375/340

(57) ABSTRACT

A system and method for communicating in a power line communications (PLC) network using Orthogonal Frequency-Division Multiplexing (OFDM) symbols. Pilot tones are carried by the OFDM symbols according to a predetermined pattern. A receiving device identifies pilot tones on each frequency. A group of previously received pilot tones on a selected frequency are filtered to generate a channel estimate for a tone on the selected frequency in a new symbol. The channel estimates on two different frequencies within an OFDM symbol may be interpolated to determine a channel estimate for a third frequency with the OFDM symbol.

### CROSS-REFERENCE TO RELATED APPLICATIONS

This application claims the benefit of the filing date of U.S. Provisional Patent Application No. 61/363,335, which is titled “Modulation Schemes for G.hnem” and was filed Jul. 12, 2010; U.S. Provisional Patent Application No. 61/380,917, which is titled “Pilot Structure for Coherent Modulation” and was filed Sep. 8, 2010; and U.S. Provisional Patent Application No. 61/391,359, which is titled “Pilot Structure for Coherent Modulation” and was filed Oct. 8, 2010, the disclosure of which is hereby incorporated by reference herein in its entirety.

### TECHNICAL FIELD

Embodiments of the invention are directed, in general, to communication systems and, more specifically to pilot structures for coherent modulation in power line communications.

### BACKGROUND

The International Telecommunication Union (ITU) Telecommunication Standardization Bureau is developing new standards—identified as G.hnem—to enable cost-effective smart grid applications such as distribution automation, smart meters, smart appliances and advanced recharging systems for electric vehicles. The G.hnem standards link electrical grids and communications networks, enabling utilities to exercise a higher level of monitoring and to support power lines as a communications medium. The G.hnem standard supports Ethernet, IPv4 and IPv6 protocols, and G.hnem-based networks can be integrated with IP-based networks. The G.hnem standards define the physical layer and the data link layer for narrowband Orthogonal Frequency-Division Multiplexing (OFDM) power line communications over alternating current and direct current electric power lines at frequencies below 500 kHz.

The format of the modulation that will be used in the G.hnem standards is being considered by the ITU. It is expected that G.hnem will support coherent modulation and that a pilot pattern shall be specified. However, a specific pilot pattern is not currently in use with the G.hnem standards.

Pilot patterns are useful in other powerline communication networks and in other communication technologies using, for example, transmission of Orthogonal Frequency-Division Multiplexing (OFDM) symbols over power lines or other media.

### SUMMARY OF THE INVENTION

A pattern of pilot tones embedded in the header and payload of OFDM symbols may be specified to improve channel estimation and to mitigate drifts in clocks and channel characteristics. Coherent modulation offers more than 2 dB performance gain over differential modulation over a wide variety of channel and noise conditions that are typically observed in powerline communication. A pilot structure is disclosed that enables channel estimation under practical conditions without incurring large implementation complexity.

### BRIEF DESCRIPTION OF THE DRAWINGS

Having thus described the invention in general terms, reference will now be made to the accompanying drawings, wherein:

FIG. 1 is a block diagram of a system for implementing embodiments of the invention;

FIG. 2 illustrates a basic pilot structure according to one embodiment;

FIG. 3 illustrates channel estimation performed in one embodiment for tones that are not pilot tones;

FIG. 4 illustrates an alternative pilot structure;

FIG. 5 illustrates a pilot structure with 8.25% overhead;

FIG. 6 illustrates a pilot structure with 16.5% overhead; and

FIG. 7 illustrates a pilot pattern combination used in another embodiment.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

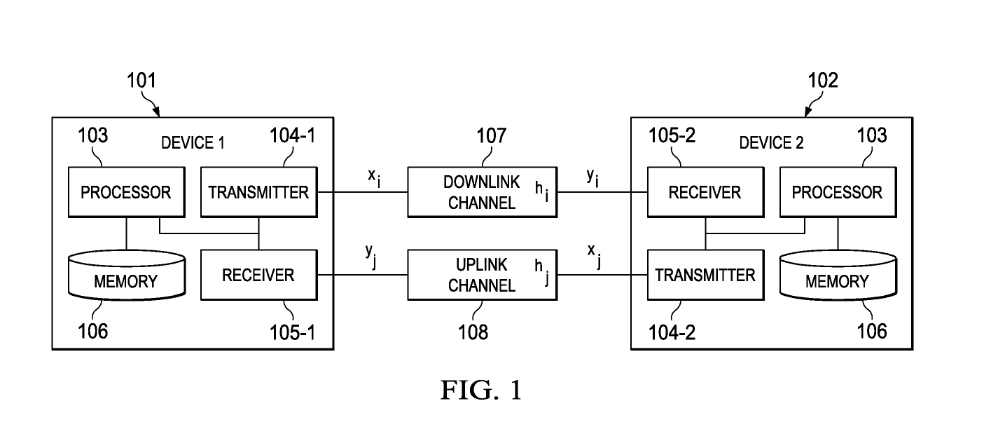

FIG. 1 is a block diagram of a system 100 for implementing embodiments of the invention. Devices 101 and 102 communicate via channels 107 and 108. Devices 101 and 102 comprise a processor 103 for processing signals to be transmitted to other devices via transmitters 104 and for processing signals received from other devices via receivers 105. Signals xᵢ are transmitted by transmitter 104-1 in device 101 across downlink channel 107 to receiver 105-2 in device 102. Downlink channel 107 has channel characteristics hᵢ that affect the transmitted signals so that modified signal yᵢ is detected at receiver 105-2. Additionally, noise nᵢ may be received or detected at receiver 105-2.

Similarly, signals xⱼ are transmitted by transmitter 104-2 in device 102 across uplink channel 108 to receiver 105-1 in device 101. Uplink channel 10 has channel characteristics hⱼ that affect the transmitted signals so that modified signal yⱼ is detected at receiver 105-1. Noise nⱼ may be received or detected at receiver 105-1. The signals yᵢ and yⱼ received at each device across channels 107 and 08 may be represented as:

yᵢ=hᵢxᵢ+nᵢ (Eq. 1)

yⱼ=hⱼxⱼ+nⱼ (Eq. 2)

Ignoring the noise component, the characteristics h of each channel may be determined using known transmitted signals x, such as known pilot signals, with observed received signals y as shown in the following equations:

hᵢ=yᵢ/xᵢ (Eq. 3)

hⱼ=yⱼ/xⱼ (Eq. 4)

Downlink channel 107 and uplink channel 108 may represent a wired or wireless interface between devices 101 and 102. For example, device 101 may be a base node, concentrator, or other device that acts as the master of the network or communication technology in a powerline communication (PLC) network. Device 102 may be a modem, meter, or other device that may benefit or need to exchange data with the base node, including, for example, a home area network, access point, base station, picocell/femtocell, electric vehicle charging station, or the like. Channels 107 and 108 in the PLC network may include transitions between medium voltage (MV) lines and low voltage (LV) lines across transformers or other interfaces. For example, device 101 may be connected to an MV line, and device 102 may be connected to an LV line that is in turn coupled to the MV line by a transformer.

The communication signals xᵢ and xⱼ may be Orthogonal Frequency-Division Multiplexing (OFDM) signals that comply with the G.hnem, PRIME (Powerline Related Intelligent Metering Evolution), or G3 standards.

In other embodiments, the devices 101 and 102 may communicate via wireless channels 107 and 108 using OFDM signals.

Processors 103 may be a software, firmware, or hardware based component, or a combination thereof. Processors 103 may also control the modulation of transmitted signals between the devices 101, 102. Memories 106 may be used to store signals and symbols to be transmitted, received signals and symbols, modulation schemes, and computer program instructions, software and firmware used by processors 103, and any other parameters needed in the course of communication. It will be understood that memory 106 may be any applicable storage device, such as a fixed or removable RAM, ROM, flash memory, or disc drive that is separate from or integral to processor 103.

It will be understood that the devices 101 and 102 in FIG. 1 are presented for illustrative purposes only and are not intended to limit the scope of the systems or devices that are capable of employing the pilot structures described herein.

The use of a regular time-frequency pilot structure enables two enhancements for systems using OFDM transmission: (1) channel estimation and (2) carrier and sampling frequency tracking Sampling frequency tracking is more relevant for narrowband PLC systems.

It is well known that coherent modulation with ideal channel estimates gives significant performance gains over differential modulation. However, two concerns have prevented widespread application of coherent modulation to narrowband PLC systems: (1) the accuracy of channel estimates in the presence of frequency-selective distortion and powerline noise, and (2) the complexity of coherent modulation. Both these concerns can be alleviated by suitably designing the communication system to aid simple, robust implementations of coherent modulation.

ITU—Telecommunication Standardization Sector Temporary Document 10GS3-059, titled “Proposal To Use Coherent Modulation For G.hnem,” dated ______, the disclosure of which is hereby incorporated by reference herein, used simulation results to demonstrate the gains of coherent over differential modulation. Additionally, low-complexity channel estimation methods were demonstrated. Texas Instruments, ad hoc call August 2010, and titled “Performance of coherent modulation,” the disclosure of which is hereby incorporated by reference herein, suggested that G.hnem adopt coherent modulation of data carriers with respect to a fixed phase reference. It is desirable to use receivers with a low-complexity method for obtaining accurate channel estimates throughout the frame and in the presence of carrier frequency drifts and other impairments. Initial channel estimates may be obtained by using preamble symbols.

For the following reasons, it is necessary to transmit regular time-frequency pilots embedded in the header and data symbols.

First, the main goal of preamble insertion is to ensure accurate synchronization. Preambles do not have to be designed to achieve the level of channel estimation accuracy that is needed for the highest modulation schemes. This is especially true in cases where preamble symbols are affected by impulsive noise, which is common in powerline systems.

Second, even if accurate channel estimates are obtained with the preamble, they may not be accurate through the frame due carrier drifts and also potential small variations in the actual channel.

Both of the above problems may be alleviated by the use of regular time-frequency pilot carriers that are embedded in the header and data symbols. Examples of proposed pilot structures are discussed in further detail below.

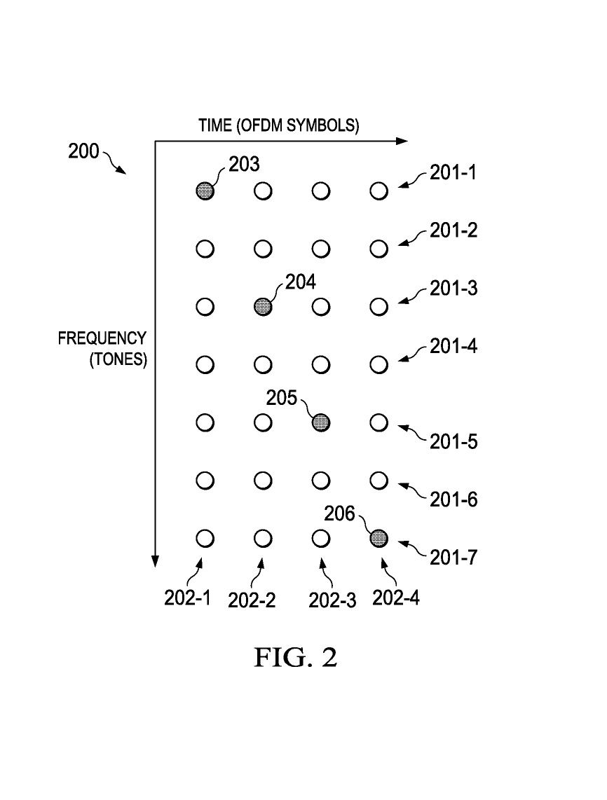

FIG. 2 illustrates a basic pilot structure. Each circle represents a carrier or a tone. The filled circles represent pilot tones where known data is transmitted. The open circles represent tones that are available for header or data communication. The grid 200 illustrated in FIG. 2 repeats in time and frequency to generate an entire PHY frame. OFDM symbols 202 each comprise eight tones 201-1 to 201-8. In any given symbol 202, every eight tone is a pilot tone 203-206. The location of the pilot tone is shifted by two tones in every symbol to create a periodic pattern. As a result, on every fourth symbol, the pilots will occur on the same tone.

The pattern used in grid 200 results in some tones 201-2, 201-4, 201-6, and 201-8 never carrying a pilot. Instead, these tones only carry data or header information. On the tones that are occasionally used for the pilot 201-1, 201-3, 201-5, and 201-7, three out of four symbols are carrying carry data or header information. The channel for these non-pilot (i.e. data or header information) tones must be estimated since the receiver does not know the content of the originally transmitted tone.

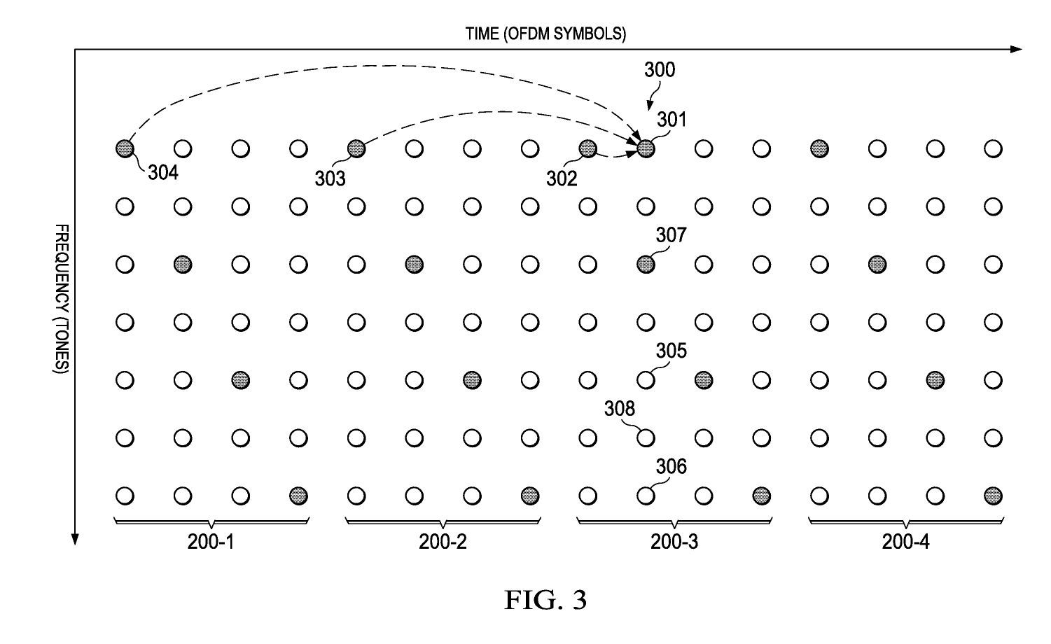

FIG. 3 illustrates how channel estimation is performed in one embodiment for tones that are not pilot tones. FIG. 3 also illustrates how the grid 200 in FIG. 2 can be continued in a repeating pattern over time. Four repetitions 200-1 to 200-4 are illustrated in FIG. 3. This pattern may be repeated as long as required to transmit data between two or more devices.

Tone 301 is not a pilot tone, but instead carries data or header information. The receiver must estimate the channel for tone 301 in order to recover the transmitted data. Channel estimation may be done by time interpolation followed by frequency interpolation. FIG. 3 illustrates one embodiment of time interpolation. For every new symbol 301, the three previous pilots on the same frequency 302, 303, 304 are filtered to estimate the interpolated channel on that tone for the new symbol 301.

At the end of the time-interpolation process, either pilot data or interpolated estimates are available on every second tone of each OFDM symbol. For example, in symbol 300, the channel on tones 301, 305 and 306 may be estimated using time-interpolation of the three previous pilots on those tones and tone 307 can be calculated from the pilot.

Frequency interpolation may then be used to estimate the channel for the tones that are between the time-interpolated tones. For example, the channel for tone 308 may be estimated by interpolating between tones 305 and 306.

Because only past pilots are used, channel estimation is causal and does not have large latency or memory requirements. The sequence illustrated in FIG. 3, which requires two one-dimensional filters may not always be optimum, but is easy to implement and has been shown by simulation to achieve near-optimum performance.

The process illustrated in FIG. 3 also demonstrates the value of using periodic time-frequency structures. Aperiodic or near-random pilot positions increase the complexity of channel estimation for the same performance target. This can be more formally established by considering two-dimensional sampling of the time-frequency grid. Given that the time-frequency correlation spectrum is likely to be flat, uniform sampling of the time-frequency grid is the most efficient way of generating channel estimates.

Other possible pilot structures may also be considered. The regular pilot structure illustrated in FIGS. 2 and 3 is parameterized by:

the frequency spacing F between pilots in a pilot-carrying symbol;

the minimum period T of the pilot pattern; and

the number of pilot-carrying symbols T_{ON} within the period T.

The parameters determine the pilot overhead, and also the expected performance under worst-case conditions.

Maximum Channel Length. After time interpolation, pilots are available every F/T_{ON} tones, where T_{ON} is the number of pilot-carrying symbols in period and F is the frequency spacing. This effectively amounts to downsampling the channel the in frequency domain by (F/T_{ON}). The “alias-free” period of the channel estimates in the time domain is N/(F/T_{ON}), where N is the number of subcarriers. In one embodiment, channels up to N/8 long are considered. Further, there may be errors in preamble-based placement that result in the effective channel being longer. Consequently, (F/T_{ON}) should be chosen be at most four.

Time Coherence. As long as the channel length is less than N/(F/T_{ON}), it can be shown that the tolerable channel coherence time is T_{ON} symbols. If the autocorrelation function of the channel has duration less than T_{ON} symbols, then accurate channel estimation may be achieved by averaging.

In the context of powerline communication, the channel does not vary continuously. However, there is some variation in the channel. This variation is often synchronous to the mains. Further, there is also time selectivity in the noise. Consequently, it is recommended to keep T_{ON} small.

Furthermore, a small value of T_{ON} also ensures that pilots on the same tone are closer together, which implies that phase drift between pilot-carrying symbols is smaller.

Overhead. The pilot overhead is (1/F)(T_{ON}/T). It would be desirable to ensure overhead less than 10%.

Implications For Parameter Choice. Since (F/T_{ON})≦4, T_{ON}/F≧25%. Thus, in order to limit overhead to around 10%, it is necessary to ensure T>2. It is noted that choosing (F/T_{ON}) to be less than four increases the overhead for the same period without any gain in the ability to tolerate typical channel lengths.

Some example combinations are given in Table 1.

TABLE 1

| | | | Number | | |
|---|---|---|---|---|---|
| | | | of pilot- | | Maximum |
| | | Pilot | carrying | | fractional |
| | Frequency | pattern | symbols | | channel |
| Combination | spacing | period | in period | Overhead | length |
| Number | F | T | T_{ON} | (1/F)( T_{ON}/T) | F/T_{ON} |
| 1 | 8 | 8 | 8 | 12.5% | 1 |
| 2 | 8 | 4 | 4 | 12.5% | 2 |
| 3 | 12 | 6 | 6 | 8.25% | 2 |
| 4 | 6 | 4 | 2 | 8.33% | 3 |
| 5 | 12 | 4 | 4 | 8.25% | 3 |
| 6 | 6 | 2 | 2 | 16.67% | 3 |

Combinations 5 and 6 give the desired values of fractional channel length with small overhead. They also give a smaller pilot period than combinations 1 and 3. Consequently, one of patterns 5 or 6 would be useful for the G.hnem standard.

The pilot overhead in the pattern used in FIGS. 2 and 3 is 12.5%. This overhead can be halved by transmitting pilots on every alternate symbol. This modification would increase the pilot periodicity to eight. The resulting performance degradation is likely to be small since the PLC channel does not vary significantly within a few symbols.

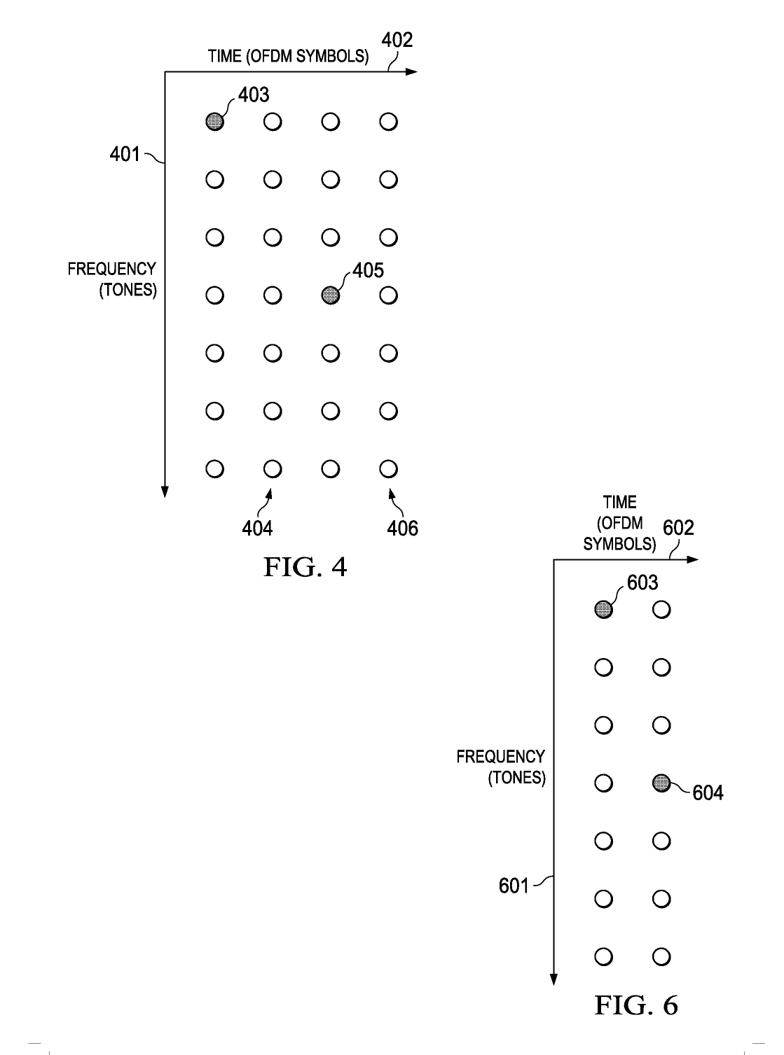

An alternative pilot structure is illustrated in FIG. 4. This pattern corresponds to combination number 4 in Table 1 and has a frequency spacing of six tones 401, and a period of four symbols. The overhead for this pattern is 8.33%. The pilot tones 403, 405 appear in every other set of symbols 402. The alternating symbols 404 and 406 do not carry pilots. This combination is adapted from 3GPP LTE.

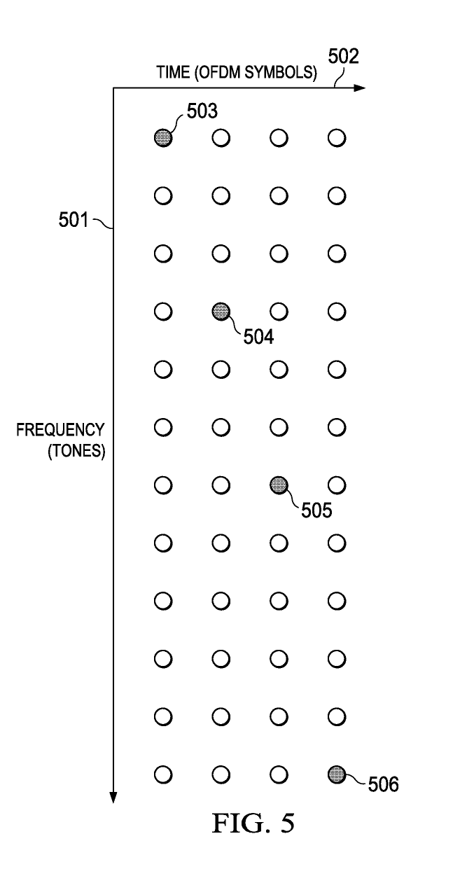

FIG. 5 illustrates combination number five in Table 1 with 8.25% overhead. This combination is used in the DVB-H (Digital Video Broadcasting-Handheld) standard. The pattern in FIG. 5 uses a frequency spacing 501 of twelve and a pilot pattern period of four. Each symbol 502 includes a pilot tone 503-506.

FIG. 6 illustrates combination number six in Table 1 with 16.5% overhead. The pattern in FIG. 6 uses a frequency spacing 601 of six and a pilot pattern period of two. Each symbol 602 includes a pilot tone 603, 604.

Choice of Pilot Parameters. As the pilot overhead decreases, the density of pilots is reduced and, therefore, the number of pilots available for averaging over the same time-frequency span is smaller. This may result in higher channel estimation error. More specifically, a larger time (or frequency) period implies the pilot structure offers poorer performance if the channel varies significantly over time (or frequency). Further, it is noted that the desired level of channel estimation accuracy is higher for higher data rates.

Two possible approaches to determine the pilot overhead are discussed below. It will be understood that other approaches may also be used.

First, the pilot overhead may be chosen as a fixed value that can offer the channel estimation accuracy to support the worst case channel variations and the highest data rate.

Second, the pilot pattern in the data symbols may be varied depending on one or more of the data rate/modulation schemes used and the channel variation statistics in time and frequency. In one embodiment, the pilot pattern for the header is always fixed to one pattern, which can be designed to support the small data rates used for the header. The pilot pattern for the data is either signaled explicitly in the header, or derived implicitly from the modulation and data rate parameters that are signaled. A higher-overhead pilot pattern may be used for higher data rates or when a higher order modulation scheme is used in some portion of the band. For example, the 8.33% overhead structure may be used for the header and for lower data rates. For higher data rates, the 12.5% overhead structure may be used. In an alternative embodiment, the pilots are transmitted in every symbol instead of having no pilots on alternate symbols.

In an example embodiment, simulation results were obtained with a 12.5% overhead pilot structure. The simulation results demonstrate the gains of coherent over differential modulation. In the simulation, it is assumed that channel estimation was obtained solely from the pilots. While these results may be improved upon by using the preamble, they offer a baseline to compare performance without having to decide on an exact preamble length.

The following channel and noise models are considered in the simulation embodiment. These parameters cover the range of impairments observed in typical powerline communication channels.

1. Single-tap channel with additive white noise.

2. Single-tap channel with strong narrowband interference in a few tones.

3. Frequency selective channel.

4. Single-tap channel with periodic impulsive noise synchronous with the AC mains.

5. Residual sampling frequency offset after initial preamble-based correction.

Of these impairments, it is noted that the first three are static phenomena, where the channel values and noise statistics do not change with time. Thus, channel estimation is simple and can be made as accurate as necessary by averaging across multiple symbols in these situations.

The fourth and fifth cases result in regular, time-varying changes in the channel values and noise statistics respectively and are the most challenging for pilot-aided channel estimation. Table 2 lists a summary of the simulation parameters and the simulation results, which show good performance even under these conditions.

TABLE 2

| Simulation parameter | Value |
|---|---|
| Coding | Outer t = 8 Reed Solomon code |
| | (251, 235) with inner Rate ½, K = 7 |
| | Convolutional code, with optional |
| | ¼ repetition |
| Modulation | (D)BPSK, (D)QPSK |
| Tone spacing | 390.625/256 kHz |
| Bandwidth used | 36 tones from 35.09 kHz to 88.5 |
| | kHz (approximately) |
| Narrow band interference | 7 adjacent tones from 59.5-68.7 |
| | kHz |
| Periodic impulsive noise | Erases 2 ms out of every 10 ms |

Single-tap channel with white noise. The performance of various schemes under white noise was also considered. It has been observed for BPSK (Binary Phase Shift Keying) and QPSK (Quadrature Phase Shift Keying) modulations with rate-½ coding. Coherent modulation with ideal channel estimates gives gains of more than 3 dB over differential modulation for BPSK modulation, and nearly 2.7 dB for QPSK modulation. Even with actual channel estimation, most of this gain is preserved.

Performance for BPSK modulation on an AWGN (Additive White Gaussian Noise) channel when ¼ repetition is used, in addition to rate-½ coding was also considered. The loss of actual channel estimation when compared to ideal is larger in this case or about 1.2 dB. Despite this loss, coherent modulation with actual channel estimation outperforms differential modulation by about 2.5 dB.

Narrowband Interference. A simulation in which narrowband noise wipes out seven adjacent tones spanning frequencies from 59.5 kHz to 68.7 kHz was also considered. A typical OFDM receiver detects the interference and erases the tones by setting the corresponding LLRs (Log-Likelihood Ratios) to zero, for example, before decoding. In this case, coherent demodulation outperforms non-coherent by 2.5 dB with both BPSK and QPSK modulations. Further, the loss from channel estimation is small.

Periodic Impulsive Noise. This is the dominant noise source in powerline communication. A simulation was considered in which it was assumes that large noise bursts of 2 ms width occur every 10 ms in addition to additive white noise. The receiver detects these bursts and sets the corresponding samples to zero before the FFT (Fast Fourier Transform). This is the case that challenges channel estimation the most due to the non-stationary nature of the noise. Consequently, the channel estimation loss is larger than the previous cases. However, despite the nearly 0.5 dB channel estimation loss, coherent demodulation was observed to outperform differential by nearly 2 dB.

Frequency Selective Channel with Periodic Impulse Noise. The performance of channel estimation with a severely frequency selective channel, in addition to periodic impulsive noise, was also studied. The magnitude and phases responses of the channel included a deep in-band notch at around 62 kHz. With the above channel, and with the periodic impulsive noise described in the previous section, simulations were run for BPSK modulation with rate-½ coding. The results indicate that loss from ideal channel estimation is around 0.5 dB. Despite this loss, coherent demodulation outperforms differential demodulation by around 3 dB.

Residual Sampling Frequency Offset. In typical powerline communication systems, there could be sampling frequency offset of around a 100 ppm between transmitter and receiver. Typically, an initial correction is done to leave a small residual frequency offset during decoding. With standard techniques, the residual offset can be limited to a very small value. This estimation may be performed either using the preamble or the pilot symbols. In a simulation, a residual value of 20 ppm was assumed for a pessimistic case. Even with such a large value, it was observed that coherent modulation offers performance gains over differential, for BPSK modulation with narrowband interference.

Specifically, while the performance of coherent modulation degrades with residual frequency offset, the impact even with a 20 ppm offset, the performance loss of coherent modulation with respect to ideal channel estimation is small (<1 dB). As expected, differential demodulation performance is not severely impacted by frequency offset. However, despite this, coherent modulation still outperforms differential by more than 2 dB at 10% FER (Frame Error Rate), even with a 20 ppm frequency offset. It is worth noting again that 20 ppm offset is pessimistic and would be worse than observed in practice.

Pilot-based channel estimation for coherent modulation is used in the embodiments herein. Simulation results are also reported for various channel and noise impairments. In all cases, it was observed that coherent modulation outperforms differential modulation. Since G.hnem targets improved performance in next-generation powerline communication systems, a regular pattern for pilot symbols may be used to aid channel estimation.

Some other considerations may be addressed when selecting the pilot pattern.

Effect of bit loading. As long as both transmitter and receiver know the pilot locations, they would account for the fact the pilot tones do not carry data bits. Thus, even though the introduction of a time-varying (but periodic) pilot pattern affects the number of per symbol, the variation is both periodic and known at the transmitter and receiver without additional signaling.

Effect of frequency-domain and time-domain impulsive noise. Both time impulsive and frequency-domain narrowband interference may result in erasure of one of more pilot tones. This is well known and is handled by standard methods. There is no evidence that one regular pilot pattern is any more resilient to noise than any other.

Adaptability of pilots. Higher data rates require greater channel estimation and carrier accuracy than lower data rates. Consequently, it may be advisable to increase the pilot overhead for the higher data rates. However, if this is done, it must be done in a regular pattern as suggested here. For example, one may switch between combination number five in Table 1 for low data rates, such as when the maximum modulation scheme in the band is QPSK, and combination number six for higher data rates.

In one embodiment, pilots shall be sent every symbol or every other symbol (header and payload). Pilots may be sent as a periodical pattern, such as in every n-th sub-carrier in symbols in which pilots are present. The value of n may be the same for all header symbols and for all payload symbols carrying the pattern. Pilot sequences of adjacent symbols carrying pilots may be shifted by k sub-carriers relative to each other. The valid range of pilot sequence parameters to pick from for both the header and payload may be:

m=0 (for sending pilot in every symbol) and 1 (for every other symbol);

n=4, 6, 8, 12;

k=3, 4; −2 (shift back); and

the combination m=0, n=4 may be excluded.

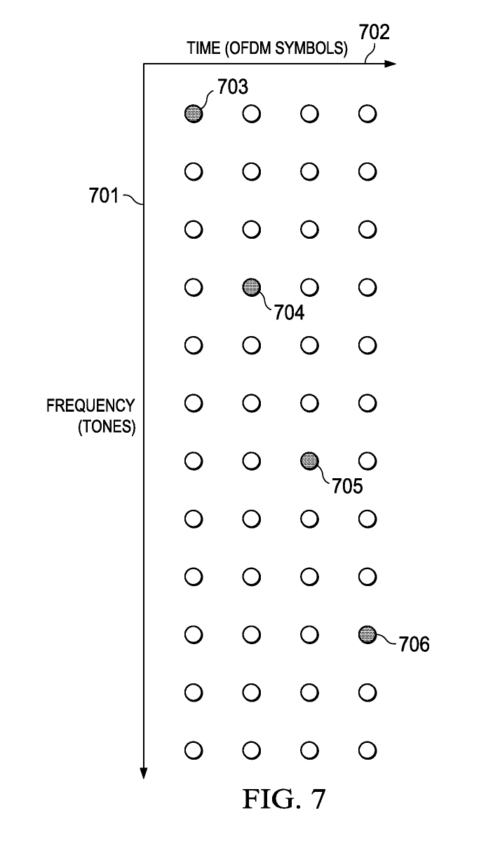

FIG. 7 illustrates a pilot pattern combination in which n=12, k=3, and m=0. The illustrated pilot structure has the following features:

pilots are carried in every OFDM symbol, on every 12th tone (m=0, n=12); and

pilots on adjacent symbols are shifted cyclically by 3 tones (k=0).

This pilot pattern ensures that there are roughly the same number of pilot tones in each OFDM symbol, and exactly the same number of pilot tone in every group of four OFDM symbols.

In some embodiments, it may be desirable to ensure the same number of pilot tones on all OFDM symbols. The total number of active carriers may be designated as M. In the pattern illustrated in FIG. 7, pilots in the i-th symbol are in locations:

K0(i)+j*n, where j=0, 1, . . . , J(i)−1 (Eq. 5)

To ensure the same number of pilot tones on all symbols, it is necessary to ensure J(i)=J for all symbols i. In order to ensure this, the above proposal can be modified as follows.

Further assume the pilot pattern period is T, and define F=n/T. This should be an integer.

The following options may be considered:

Let M0=mod(M, n).

If 0<=M0<F, J=floor(M/n);
Else, J=ceil(M/n)

Define first pilot location=K0(i)=M0+mod(i, 4)*F.

Pilots always at mod(K0(i)+j*n, N), j=0, 1, . . . , (J−1).

The above produces J pilots per OFDM symbol.

If channel estimation symbols are inserted in the middle of the header or the payload, these may or may not be counted in the symbol indexing j.

In one embodiment, the recommended solution is to NOT count these, i.e., j is incremented by just one between the last symbol before a CES (Channel Estimation Signals) burst and the first symbol after a CES burst.

Header Decoding Performance. In some embodiments, pilots are used only for tracking at least during the header OFDM symbols, with channel estimation based on preambles. To accommodate such an implementation, the pilot overhead during the header may be increased. The reason for this appears to be that preamble-based clock offset estimation is not accurate, and the initial high density of pilots may be used to compensate for the lack of accurate clock estimation. At the end of the header, the clock drift has presumably been detected accurately, and one can then reduce the pilot density.

In other embodiments, simulation results have demonstrated that pilot-based channel estimation in the header significantly outperforms purely preamble-based channel estimation, even without increasing the header overhead. The performance of pilot-based and preamble-based channel estimation has been simulated for different values of residual frequency offset after the initial preamble-based drift estimate.

In one simulation, a 16-byte header was modulated with QPSK, coded with a rate-½ convolutional code and repeated 12 times. Various residual sampling frequency offsets are considered, after the initial preamble-based sampling frequency estimate. Pilot-based channel estimation was observed to outperform preamble-based channel estimation for all residual offsets (50 ppm, 100 ppm, 200 ppm) by amounts varying from 4 dB to unlimited.

One might argue that this could be combated by (i) reducing the residual offset from preamble-based estimation, and (ii) using the header symbols to refine the offset, particularly with more pilots in the header. However, this is not easily achievable. A well-known method to estimate sampling frequency offset is to estimate the average phase rotation between the same tone on different symbols on the preamble. The cdf (cumulative distribution function) of the residual sampling frequency estimation error for various averaging lengths was observed in simulations, and it was noted that it takes 10 symbols to get the error below 50 ppm. This holds despite the fact that all tones are available for sampling frequency offset estimation in the preamble, whereas in the pilots at most one in six pilots is available (even with n=6, m=0).

Using only preamble-based channel estimates is one of many possible implementations, but it is not a high-performing method. Consequently, in some embodiments, the overhead in the header is not increased to accommodate a sub-optimum implementation, particularly when it is not clear that increasing the overhead will fix the central problem it seeks to solve.

Pilot Sequence Calculation. Another aspect to be considered is the choice of pilot sequences themselves. It may be desirable to avoid spectral lines caused by using the same value transmitted at all pilot tone locations. Using a pseudo-random sequence may help to avoid these lines. In addition, using a pseudo-random sequence with different initializations for different domains may also help to reduce noise in the channel estimates from two different domains.

In one embodiment, the pilot carriers may be QPSK modulation based on the outputs of the pseudo-random sequence generated by the linear feedback shift register (LFSR) with the polynomial p(x)=x7+x4+1.

Many of the functions described herein may be implemented in hardware, software, and/or firmware, and/or any combination thereof. When implemented in software, code segments perform the necessary tasks or steps. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

The software code segments may be stored in any volatile or non-volatile storage device, such as a hard drive, flash memory, solid state memory, optical disk, CD, DVD, computer program product, or other memory device, that provides computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method, comprising:
receiving a plurality of Orthogonal Frequency-Division Multiplexing (OFDM) symbols transmitted from a first device to a second device, each of the OFDM symbols having a plurality of tones;
identifying pilot tones in the OFDM symbols, the pilot tones occurring in a periodical pattern; and
filtering a predetermined number of pilot tones occurring on a selected frequency to determine an interpolated channel estimate for the selected frequency.

2. The method of claim 1, further comprising:
generating an interpolated channel estimate for a first frequency at a selected time;
generating an interpolated channel estimate for a second frequency at the selected time; and
interpolating between the interpolated channel estimate for the first frequency and the interpolated channel estimate for the second frequency to generate an interpolated channel estimate for a third frequency at the selected time.

3. The method of claim 2, wherein the third frequency is between the first frequency and the second frequency.

4. The method of claim 2, wherein the interpolated channel estimates for the first, second and third frequencies are associated with a single symbol.

5. The method of claim 1, further comprising:
identifying pilot tone channel characteristics associated with a pilot tone for a first frequency at a selected time;
generating an interpolated channel estimate for a second frequency at the selected time; and
interpolating between the channel characteristics and the interpolated channel estimate for the second frequency to generate an interpolated channel estimate for a third frequency at the selected time.

6. The method of claim 1, wherein the filtering step further comprises:
filtering a last three pilot tones occurring on the selected frequency to determine an interpolated channel estimate for the selected frequency.

7. The method of claim 1, wherein pilot tones are carried on every twelfth frequency in every OFDM symbol; and
wherein the pilot tones on adjacent symbols are shifted cyclically by three tones.

8. The method of claim 1, wherein the pilot tones do not appear on each tone in the OFDM symbols.

9. An apparatus, comprising:
a receiver adapted to receive a plurality of Orthogonal Frequency-Division Multiplexing (OFDM) symbols, each of the OFDM symbols having a plurality of tones; and
a processor coupled to the receiver, the processor adapted to identify pilot tones in the OFDM symbols, the pilot tones occurring in a periodical pattern, and to filter a predetermined number of pilot tones occurring on a selected frequency to determine an interpolated channel estimate for the selected frequency.

10. The apparatus of claim 9, wherein the processor is further adapted to:
generate an interpolated channel estimate for a first frequency at a selected time;
generate an interpolated channel estimate for a second frequency at the selected time; and
interpolate between the interpolated channel estimate for the first frequency and the interpolated channel estimate for the second frequency to generate an interpolated channel estimate for a third frequency at the selected time.

11. The apparatus of claim 10, wherein the third frequency is between the first frequency and the second frequency.

12. The apparatus of claim 10, wherein the interpolated channel estimates for the first, second and third frequencies are associated with a single symbol.

13. The apparatus of claim 9, wherein the processor is further adapted to:
identify pilot tone channel characteristics associated with a pilot tone for a first frequency at a selected time;
generate an interpolated channel estimate for a second frequency at the selected time; and
interpolate between the channel characteristics and the interpolated channel estimate for the second frequency to generate an interpolated channel estimate for a third frequency at the selected time.

14. The apparatus of claim 9, wherein the processor is further adapted to:
filter a last three pilot tones occurring on the selected frequency to determine an interpolated channel estimate for the selected frequency.

15. The apparatus of claim 9, wherein pilot tones are carried on every twelfth frequency in every OFDM symbol; and
wherein the pilot tones on adjacent symbols are shifted cyclically by three tones.

16. The apparatus of claim 9, wherein pilot tones never occur on certain tones of the OFDM symbols.

17. The apparatus of claim 9, wherein pilot tones do not occur on alternating OFDM symbols.
